(19) United States
(12) Patent Application Publication
(10) Pub. No.: US 2021/0006105 A1
(43) Pub. Date: Jan. 7, 2021

(54) Rotor for Separately Excited Inner Rotor Synchronous Machine, Inner Rotor Synchronous Machine, Motor Vehicle and Method

(71) Applicant: Bayerische Motoren Werke Aktiengesellschaft, Muenchen (DE)

(72) Inventors: Silko FEUSTEL, Muenchen (DE); Bernhard HUEBNER, Eching - Viecht (DE); Daniel LOOS, Muenchen (DE); Joerg MERWERTH, Dachau (DE); Yann TREMAUDANT, Muenchen (DE); Klaus VOLLMER, Muenchen (DE)

(21) Appl. No.: 16/966,133

(22) PCT Filed: Jul. 15, 2019
(86) PCT No.: PCT/EP2019/068947

§ 371 Date: Jul. 30, 2020

(30) Foreign Application Priority Data
Aug. 13, 2018 (DE) 10 2018 213 567.3

(51) Int. Cl. H02K 1/24; H02K 3/487; H02K 15/02; B60K 1/00

(52) U.S. Cl. CPC H02K 1/24; B60K 1/00; H02K 15/022; H02K 3/487

(57) ABSTRACT

A rotor for a separately excited inner rotor synchronous machine of an electrically drivable motor vehicle, having a plurality of rotor windings for forming a rotor magnetic field and a rotor core for holding the rotor windings, wherein the rotor core has an annular rotor yoke with a number of rotor poles corresponding to a number of rotor windings. The poles are arranged along a rotor circumference on the rotor yoke and the rotor windings are arranged on the poles, wherein the rotor poles are formed of multiple parts and each has a rotor tooth and at least one pole shoe element separate therefrom. The rotor teeth are formed as a single piece with the rotor yoke, and the pole shoe elements are mechanically connectable to the rotor teeth after arranging the rotor windings on the rotor teeth. Also provided are the synchronous machine, a motor vehicle and a method.

### BACKGROUND AND SUMMARY OF THE INVENTION

The invention relates to a rotor for a separately excited inner rotor synchronous machine of an electrically drivable motor vehicle, having a plurality of rotor windings for forming a rotor magnetic field and a rotor core for holding the rotor windings, wherein the rotor core has an annular rotor yoke with a number of rotor poles corresponding to a number of rotor windings, which poles are arranged along a rotor circumference on the rotor yoke and on which the rotor windings are arranged. The invention also relates to an inner rotor synchronous machine, a motor vehicle and a method for producing the rotor.

In the present case, interest is directed to separately excited synchronous machines for electrically drivable motor vehicles, for example electric or hybrid vehicles. Such separately excited synchronous machines have a stationary stator with energizable stator windings and a rotor which is rotatably mounted with respect to the stator and has energizable rotor windings. The synchronous machine can be constructed as an inner rotor, in which the stationary rotor encloses the rotor, or as an outer rotor, in which the rotor encloses the stationary stator. The rotor has a rotor core, which carries the rotor windings. The rotor core is normally a one-piece iron core comprising an annular rotor yoke and a plurality of rotor poles, which are arranged along a rotor circumference on the rotor yoke. The rotor poles usually comprise a rotor tooth or rotor shaft projecting radially from the rotor yoke, and a circular segment-shaped pole shoe projecting tangentially from the rotor tooth. The pole shoes form a cylindrical rotor circumference of the rotor core. Rotor grooves, into which the rotor windings are introduced, are formed between the rotor teeth.

In order to introduce the rotor windings into the rotor grooves, the pole shoes of two adjacent rotor poles are arranged at a distance from each other, so that they expose an access opening into the rotor grooves on the rotor circumference. To arrange the rotor windings on the rotor teeth, a winding wire is introduced into the rotor grooves via the access openings by using a tool. Then, the winding wire is wound around the rotor teeth, the intention being to achieve a high filling factor. As a result of the tangentially projecting pole shoes, the access openings into the rotor grooves are smaller than a groove diameter, so that the rotor grooves can be filled with the winding wire only with great difficulty. The result is a non-optimal winding quality, and therefore a non-optimal filling factor.

To this end, DE 10 2016 213 215 A1 discloses an electric synchronous machine formed as an outer rotor, which has a rotor formed of multiple parts. Here, the rotor is built from a rotor yoke and independently formed rotor poles that can be fixed to the rotor yoke. As a result, the rotor poles can be populated with pre-wound rotor windings before they are fixed to the rotor yoke. The rotor poles pre-tailored in this way and each carrying a rotor winding are then fixed to the rotor yoke. However, such a rotor can be used only in an outer rotor synchronous machine. Were the rotor poles of a rotor of an inner rotor synchronous machine to be formed separately from the rotor yoke, then high centrifugal forces would act on a connecting region between the rotor yoke and the rotor poles during operation. In particular at high rotor peripheral speeds and high rotational speeds, it is possible that the connecting regions would not withstand the centrifugal forces and that the rotor poles would be detached from the rotor yoke.

It is an object of the present invention to provide a mechanically stable rotor for an inner rotor synchronous machine of an electrically drivable motor vehicle, the rotor core of which can be populated with rotor windings simply and with a high filling factor, and which is suitable for high rotational speeds.

According to the invention, this object is achieved by a rotor, an inner rotor synchronous machine, a motor vehicle and a method having the features according to the respective independent patent claims. Advantageous embodiments of the invention are the subject matter of the dependent patent claims, the description and the figures.

A rotor according to the invention for a separately excited inner rotor synchronous machine of an electrically drivable motor vehicle has a plurality of rotor windings for forming a rotor magnetic field and a rotor core for holding the rotor windings. The rotor core has an annular rotor yoke with a number of rotor poles corresponding to a number of rotor windings, which poles are arranged along a rotor circumference on the rotor yoke and on which the rotor windings are arranged. Furthermore, the rotor poles are formed of multiple parts and each has a rotor tooth and at least one pole shoe element separate therefrom, wherein the rotor teeth are formed in one piece with the rotor yoke, and the pole shoe elements can be mechanically connected to the rotor teeth after arranging the rotor windings on the rotor teeth.

The invention additionally relates to a method for producing a rotor according to the invention. For this purpose, firstly the rotor yoke having the rotor teeth is provided and pre-wound rotor windings are pushed onto the rotor teeth. Then, the pole shoe elements are mechanically connected to the associated rotor teeth holding the pushed on rotor windings.

The rotor of the inner rotor synchronous machine can be arranged within a cylindrical laminated core of a stator and mounted rotatably with respect to the stator. The rotor is therefore designed to rotate about an axis of rotation within the stator. The rotor can be coupled to a drive shaft of the motor vehicle for the transmission of torque. The rotor has the rotor core and the rotor windings or rotor coils. The rotor core can, for example, be formed from iron. The rotor core is formed in multiple parts, wherein here the rotor poles are formed of multiple parts. The rotor poles each have the rotor tooth or rotor shaft and the at least one pole shoe element separate therefrom. The rotor teeth and the pole shoe elements can be mechanically connected to each other during the production of the rotor.

The rotor teeth of the rotor poles are formed monolithically with the annular rotor yoke. The rotor teeth are arranged at a distance from each other along the rotor circumference, forming rotor grooves, and project radially outward. The rotor yoke and the rotor teeth thus form an externally toothed gear ring; the rotor teeth in particular have a substantially rectangular cross section. In particular, a diameter of a rotor tooth in an inner section adjacent to the rotor yoke is approximately exactly the same size as an outer section located further out and adjacent to an access opening into the rotor grooves. The rotor yoke and the rotor teeth are therefore formed without pole shoes. As a result of the lack of the pole shoe, the rotor grooves are completely open. Because of the open rotor grooves, a pre-wound rotor coil or a pre-tailored rotor winding can be pushed or plugged onto the rotor teeth particularly simply.

After the rotor windings have been pushed onto the rotor teeth, the pole shoe elements are fixed to the rotor teeth. As a result of connecting the pole shoe elements to the rotor teeth, a connecting region is formed between the rotor teeth carrying the rotor windings and the pole shoe elements. As a result of arranging the least one pole shoe element on the rotor tooth, the rotor pole has a first section which has the rotor tooth and which carries the rotor windings, and a tangential second section in the form of a pole shoe which has the at least one pole shoe element. The second section has a larger diameter than the first section. The second section, in the form of a pole shoe, is designed, amongst other things, to prevent the rotor windings being detached from the rotor poles during the rotation of the rotor because of the centrifugal force acting radially outward.

As a result of forming the rotor core in multiple parts, it can be populated particularly simply with rotor windings during the production of the rotor. The fact that the connecting region is formed between the rotor teeth and the pole shoe elements here, means that the connecting region has to hold a considerably lower mass—specifically that of the pole shoe elements—during the rotation of the rotor than a connecting region between the rotor yoke and the rotor poles, which must hold the rotor poles and the rotor windings. The rotor thus exhibits high stability, even at high rotor peripheral speeds, and can also be used for synchronous machines with high rotational speeds.

Preferably, a winding wire of the rotor windings has a rectangular, in particular square, cross section. The winding wire can, for example, also be a shaped rod, so that the rotor windings are formed as shaped rod windings. By means of the rotor teeth having no pole shoes, which are exposed during the production of the rotor, such shaped rod windings can be pre-tailored simply and plugged onto the rotor teeth. By means of such winding wires having a rectangular cross section, a higher filling factor in the rotor grooves and high mechanical stability of the rotor windings can be provided.

Particularly preferably, each rotor pole has two pole shoe elements, which can be arranged on two sides of the rotor tooth which are opposite in the tangential direction, and can be mechanically connected to the rotor tooth. The inner section of the rotor tooth is connected to the rotor yoke and carries the rotor windings. The outer section, which is arranged in the region of the access opening into the rotor grooves, can be mechanically connected to the two pole shoe elements on its tangentially opposite sides in the rotor circumferential direction. The two pole shoe elements and the outer section of the rotor tooth form the in particular circular segment-shaped pole shoe of the rotor pole, wherein the pole shoe faces an air gap between the rotor and the stator when the rotor is arranged in the stator. The pole shoe elements form a region of the pole shoe that projects tangentially and laterally beyond the rotor tooth. The pole shoe elements are therefore arranged laterally on the respective rotor tooth and held there, a holding force acting in the tangential direction here. In particular, the holding force does not have to act or act completely counter to the centrifugal force.

Preferably, the pole shoe elements and the rotor teeth can be connected in a form-fitting manner and, to this end, have connecting elements corresponding to one another, which can be plugged together in the axial direction. In particular, the rotor tooth has a first connecting element in the form of a groove, and the pole shoe element has a second connecting element corresponding thereto in the form of a pin, wherein the groove and the pin interact according the key-lock principle. The pin of the pole shoe element can therefore be pushed into the groove of the rotor tooth in the axial direction oriented along the axis of rotation of the rotor, so that the rotor tooth and the pole shoe element can be connected in a form-fitting manner in the radial and tangential direction. In the event that each rotor tooth is to be connected to two pole shoe elements, the two tangentially opposite sides of the outer section each have a groove for the respective pin of the pole shoe element. The shape of the groove and the shape of the pin correspond to each other, that is to say interact on the key-lock principle. The connecting elements which form the form-fitting connection can thus be plugged together with an accurate fit. For example, groove and pin can form a dovetail connection, the groove and the pin each having a trapezoidal cross-section. Groove and pin can also have a circular or teardrop-shaped cross section.

In an advantageous development of the invention, mutually adjacent pole shoe elements of two rotor poles that are adjacent along the rotor circumference are mechanically connected to each other via a reinforcing element to increase the mechanical strength of the rotor core in the tangential direction. According to the prior art, openings in the rotor circumference are formed by the pole shoe elements spaced apart along the rotor circumference, forming access openings into the rotor grooves and reducing the rigidity and mechanical strength of the rotor core. As a result, a maximum rotor peripheral speed and therefore a maximum rotational speed of the inner rotor synchronous machine are restricted. In order to increase the rigidity, the reinforcing elements are provided, which link the pole shoe elements tangentially in pairs and, as a result, are designed to at least partly close the opening formed between the pole shoe elements of the adjacent rotor poles. By means of the reinforcing elements, the rotor core is therefore reinforced and the rigidity of the rotor core is increased. Thus, higher rotor peripheral speeds and therefore higher rotational speeds are made possible.

Provision can be made for the reinforcing elements to be formed in the shape of a T-piece and each to have a tangential reinforcing region, via which the adjacent pole shoe elements are connected to each other, and each to have a radial reinforcing region, which can be connected to the rotor yoke to increase the mechanical strength of the rotor core in the radial direction. By attaching the pole shoe elements connected mechanically to one another via the tangential reinforcing region to the respective rotor poles, the radial reinforcing region is arranged on the rotor yoke and positioned in a rotor groove between two adjacent rotor windings. In particular, the radial reinforcing region and the rotor yoke can be connected in a form-fitting manner and, for this purpose, have mutually corresponding connecting elements which can be plugged together in the axial direction. To this end, the rotor yoke can, for example, have a third connecting element in the form of a groove, and the radial reinforcing region can have a fourth connecting element corresponding thereto in the form of a pin, which interact on the key-lock principle. By means of the connecting elements, the reinforcing element is anchored radially, so that the mechanical load-bearing ability can be increased further.

It proves to be advantageous if two mutually adjacent pole shoe elements and the reinforcing element are formed in a single piece. Two adjacent pole shoe elements and a reinforcing element located between them thus form a monolithic unit. Thus, the rotor can be assembled in a few method steps. As a result of the single-piece construction, the monolithic unit already exhibits high rigidity.

Provision can be made for a temperature of the reinforcing element to be increased during the production of the rotor, and for the pole shoe elements to be arranged with the reinforcing elements on the rotor teeth. The reinforcing elements are thus joined at elevated temperature, so that mounting with play is possible. After the reinforcing elements have cooled, they are pre-stressed, which means that rigidity is increased further. In addition, if the rotor is pressed onto a shaft, for example the drive shaft, a press fit between the shaft and the rotor can pre-stress the reinforcing elements, in particular in the tangential reinforcing region.

The invention also relates to a separately excited inner rotor synchronous machine for an electrically drivable motor vehicle, having a stator with a hollow cylindrical laminated core and a rotor according to the invention that is surrounded by the hollow cylindrical laminated core, wherein the rotor is rotatably mounted within the hollow cylindrical laminated core. The inner rotor synchronous machine is in particular a drive machine for the motor vehicle.

A motor vehicle according to the invention comprises an inner rotor synchronous machine according to the invention. The motor vehicle is in particular constructed as an electric or hybrid vehicle.

The embodiments and advantages thereof presented with reference to the rotor according to the invention apply in a corresponding way to the separately excited inner rotor synchronous machine according to the invention, to the motor vehicle according to the invention and to the method according to the invention.

Further features of the invention can be gathered from the claims, the figures and the description of the figures. The features and feature combinations named above in the description, and also the features and feature combinations named in the description of the figures and/or shown on their own in the figures, can be used not only in the respectively specified combination but also in other combinations or on their own.

### BRIEF DESCRIPTION OF THE DRAWINGS

The invention will now be explained in detail by using an exemplary embodiment and with reference to the drawings, in which:

FIG. 1 shows a schematic illustration of a rotor according to the prior art;

FIGS. 2a and 2b show a schematic illustration of a first embodiment of a rotor according to the invention during production of the rotor;

FIG. 3 shows a schematic illustration of a second embodiment of a rotor according to the invention; and

FIG. 4 shows a schematic illustration of a third embodiment of a rotor according to the invention.

### DETAILED DESCRIPTION OF THE DRAWINGS

In the figures, the same and functionally identical elements are provided with the same designations.

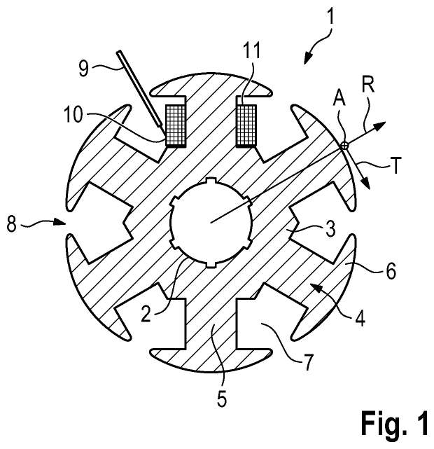

FIG. 1 shows a rotor 1 for an inner rotor synchronous machine according to the prior art, not shown here, during manufacture. The rotor 1 has a single-piece rotor core 2, which is composed of an annular rotor yoke 3 and a multiplicity of rotor poles 4. The rotor poles 3 each have a rotor tooth 5 and a pole shoe 6, which is wider as compared with the rotor tooth 5. The rotor poles 3 thus have a diameter which is inhomogeneous and widens toward the outside in a radial direction R. Between two adjacent rotor poles 3, a rotor groove 7 is formed in each case and, on account of the pole shoes 6, has a narrowed access opening 8. Via the access opening 8, a tool 9 is introduced into the rotor groove 7, by means of which tool a winding wire 10 for forming a rotor winding 11 is wound around the rotor tooth 5. Because of the narrowed access opening 8, winding around the rotor teeth 5 is very time-consuming; often only a low winding quality and therefore a low filling factor can be provided.

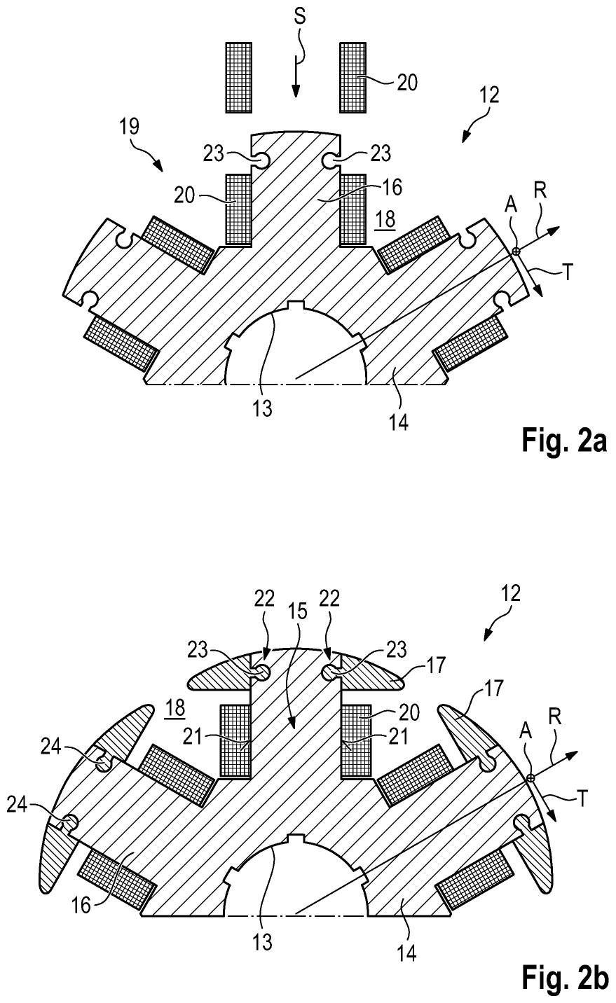

FIG. 2a and FIG. 2b show a detail of an embodiment of a rotor 12 according to the invention during production. The rotor 12 has a rotor core 13 with an annular rotor yoke 14 and rotor poles 15 formed of many parts (see FIG. 2b). The rotor poles 15 have rotor teeth 16, which are formed in a single piece with the rotor yoke 14. The rotor teeth 16 extend outward in the radial direction R, starting from the rotor yoke 14, and have a homogeneous diameter along the radial direction R. In addition, the rotor poles 15 here each have two pole shoe elements 17 separate from the rotor teeth 16 (see FIG. 2b), which can be connected to the rotor teeth 16.

In FIG. 2a, the pole shoe elements 17 are not arranged on the rotor teeth 16, so that rotor grooves 18 between the rotor teeth 16 are completely open. A respective access opening 19 to the rotor grooves 18 is thus not narrowed. As a result, pre-wound rotor windings 20 can be pushed onto the rotor teeth 16 in a fitting direction S, which is oriented counter to the radial direction R. After the rotor windings 20 have been fitted, the pole shoe elements 17 can be fixed to the rotor teeth 16. Here, two pole shoe elements 17 can be arranged on tangentially opposite sides 21 of the rotor teeth 16. The pole shoe elements 17 extend in the tangential direction T and widen the diameter of the rotor poles 15 toward the outside.

To fix the pole shoe elements 17 to the rotor teeth 16, the rotor teeth and the pole shoe elements 17 have mutually corresponding connecting elements 22, which can be plugged together in the axial direction A (into the plane of the drawing) and, as a result, connect the pole shoe elements 17 and the respective rotor tooth 16 in a form-fitting manner. The connecting elements 22 of the rotor teeth 16 are formed here as grooves 23 extending in the axial direction A, which are arranged on the sides 21 of rotor teeth 16. The connecting elements 22 of the pole shoe elements 17 are formed as pins 24 extruded in the axial direction A, which can be pushed into the grooves 23 in the axial direction A.

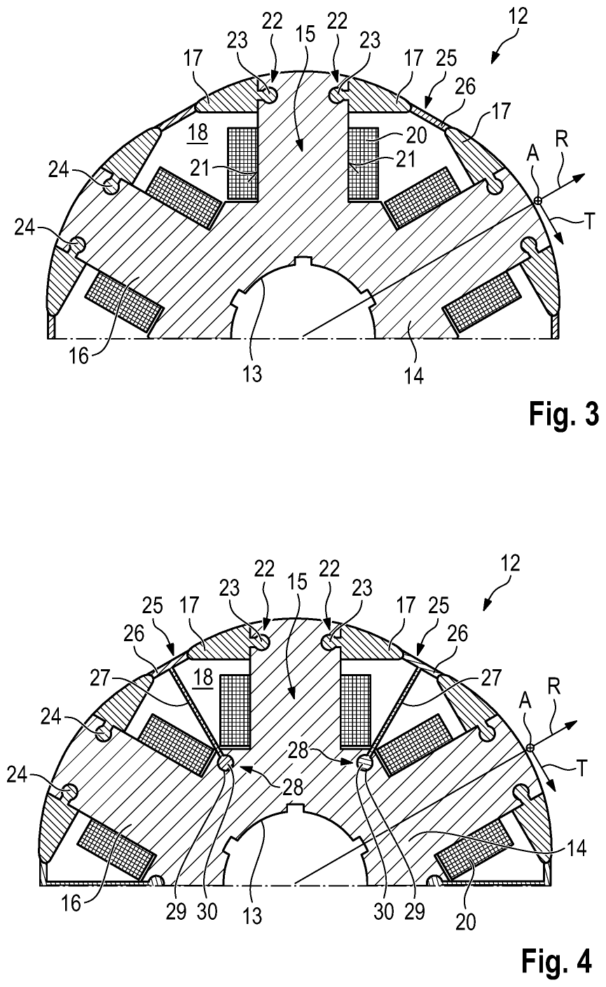

FIG. 3 shows a development of the rotor 12 which has more reinforcing elements 25. The reinforcing elements 25 have a tangential reinforcing region 26, by which the pole shoe elements 17 of two adjacent rotor poles 15 are mechanically connected to each other. By means of the tangential reinforcing region 26, the access opening 19 to a rotor groove 18 is in particular completely closed, so that the mechanical rigidity of the rotor core 13 is increased. In FIG. 4, the reinforcing elements 25 have radial reinforcing regions 27 in addition to the tangential reinforcing regions 26, so that the reinforcing elements 25 have a cross section in the shape of a T-piece. The radial reinforcing regions 27 are arranged in the rotor groove 18 between two rotor windings 20 and are mechanically connected to the rotor yoke 14. To this end, the rotor yoke 14 and the radial reinforcing regions 27 have mutually corresponding connecting elements 28, by which the rotor yoke 14 and the radial reinforcing region 27 are connected in a form-fitting manner. For this purpose, the rotor yoke 14 can have a groove 29, into which a pin 30 of the radial reinforcing region 27 can be pushed in the axial direction A for the form-fitting connection.

The pole shoe elements 17 connected in pairs via a reinforcing element 25, and the reinforcing element 25 are formed in a single piece. To finish the rotor 12 after the rotor windings 20 have been fitted onto the rotor teeth 16, the monolithic units, which each comprise two adjacent pole shoe elements 17 and a reinforcing element 25, are plugged in the axial direction onto the monolithic unit which comprises the rotor yoke 14 and the rotor teeth 16, by the pins 24 of the pole shoe elements 17 being pushed into the grooves 29 of the rotor teeth 16, and the pins 30 of the radial reinforcing regions 27 being pushed into the grooves 29 of the rotor yoke 14. The monolithic units can also be joined together at elevated temperature, so that after the monolithic units have cooled, the reinforcing elements 25 for increasing the mechanical rigidity of the rotor core 13 are prestressed.

### LIST OF DESIGNATIONS

1 Rotor
2 Rotor core
3 Rotor yoke
4 Rotor pole
5 Rotor tooth
6 Pole shoe
7 Rotor groove
8 Access opening
9 Tool
10 Winding wire
11 Rotor winding
12 Rotor
13 Rotor core
14 Rotor yoke
15 Rotor pole
16 Rotor tooth
17 Pole shoe element
18 Rotor groove
19 Access opening
20 Rotor windings
21 Sides
22 Connecting elements
23 Groove
24 Pin
25 Reinforcing element
26 Tangential reinforcing region
27 Radial reinforcing region
28 Connecting elements
29 Groove
30 Pin
R Radial direction
T Tangential direction
A Axial direction
S Fitting direction

1.-12. (canceled)

13. A rotor for a separately excited inner rotor synchronous machine of an electrically drivable motor vehicle, the rotor comprising:
a plurality of rotor windings for forming a rotor magnetic field; and
a rotor core for holding the rotor windings, wherein the rotor core has an annular rotor yoke with a number of rotor poles corresponding to a number of rotor windings, which poles are arranged along a rotor circumference on the rotor yoke and on which the rotor windings are arranged;
wherein the rotor poles are formed of multiple parts and each have a rotor tooth and at least one pole shoe element separate therefrom, and
wherein the rotor teeth are formed in a single piece with the rotor yoke, and the pole shoe elements are mechanically connectable to the rotor teeth after arranging the rotor windings on the rotor teeth.

14. The rotor according to claim 13,
wherein each rotor pole has two pole shoe elements, which are arranged on two opposite sides of the rotor tooth in the tangential direction and are connectable to the rotor tooth.

15. The rotor according to claim 13,
wherein the pole shoe elements and the rotor teeth are connected in a form-fitting manner and have mutually corresponding connecting elements, which are pluggable together in the axial direction.

16. The rotor according to claim 15,
wherein the rotor tooth has a first connecting element in the form of a groove, and the pole shoe element has a second connecting element corresponding thereto in the form of a pin, wherein the groove and the pin interact according to the key-lock principle.

17. The rotor according to claim 13,
wherein mutually adjacent pole shoe elements of two rotor poles that are adjacent along the rotor circumference are mechanically connected to each other via a reinforcing element to increase mechanical strength of the rotor core in the tangential direction.

18. The rotor according to claim 17,
wherein the reinforcing elements are formed in the shape of a T-piece and each has a tangential reinforcing region, via which the pole shoe elements are mechanically connected to each other, and each has a radial reinforcing region, which is connectable to the rotor yoke to increase the mechanical strength of the rotor core in the radial direction.

19. The rotor according to claim 18,
wherein the radial reinforcing region and the rotor yoke are connectable in a form-fitting manner and, to this end, have connecting elements corresponding to one another, which are pluggable together in the axial direction.

20. The rotor according claim 17,
wherein two mutually adjacent pole shoe elements and the associated reinforcing element are formed in a single piece.

21. The rotor according to claim 13,
wherein a winding wire of the rotor windings has a rectangular cross section.

22. A method for producing a rotor for a separately excited inner rotor synchronous machine of an electrically drivable motor vehicle, the rotor including a plurality of rotor windings for forming a rotor magnetic field and a rotor core for holding the rotor windings, wherein the rotor core has an annular rotor yoke with a number of rotor poles corresponding to a number of rotor windings, which poles are arranged along a rotor circumference on the rotor yoke and on which the rotor windings are arranged; wherein the rotor poles are formed of multiple parts and each have a rotor tooth and at least one pole shoe element separate therefrom, and wherein the rotor teeth are formed in a single piece with the rotor yoke, and the pole shoe elements are mechanically connectable to the rotor teeth after arranging the rotor windings on the rotor teeth, the method comprising:
providing the rotor core with the rotor teeth;
pushing the pre-wound rotor windings onto the rotor teeth; and
connecting the pole shoe elements to associated rotor teeth holding the pushed-on rotor windings.

23. A separately excited inner rotor synchronous machine for an electrically drivable motor vehicle, the separately excited inner rotor synchronous machine comprising:
a stator with a hollow cylindrical laminated core; and
a rotor surrounded by the hollow cylindrical laminated core,
wherein the rotor includes a plurality of rotor windings for forming a rotor magnetic field; and a rotor core for holding the rotor windings,
wherein the rotor core has an annular rotor yoke with a number of rotor poles corresponding to a number of rotor windings, which poles are arranged along a rotor circumference on the rotor yoke and on which the rotor windings are arranged;
wherein the rotor poles are formed of multiple parts and each have a rotor tooth and at least one pole shoe element separate therefrom, and wherein the rotor teeth are formed in a single piece with the rotor yoke, and the pole shoe elements are mechanically connectable to the rotor teeth after arranging the rotor windings on the rotor teeth; and
wherein the rotor is rotatably mounted within the hollow cylindrical laminated core of the stator.

24. A motor vehicle comprising:
a separately excited inner rotor synchronous machine for an electrically drivable motor vehicle, the separately excited inner rotor synchronous machine comprising:
a stator with a hollow cylindrical laminated core; and
a rotor surrounded by the hollow cylindrical laminated core,
wherein the rotor includes a plurality of rotor windings for forming a rotor magnetic field; and a rotor core for holding the rotor windings,
wherein the rotor core has an annular rotor yoke with a number of rotor poles corresponding to a number of rotor windings, which poles are arranged along a rotor circumference on the rotor yoke and on which the rotor windings are arranged;
wherein the rotor poles are formed of multiple parts and each have a rotor tooth and at least one pole shoe element separate therefrom, and wherein the rotor teeth are formed in a single piece with the rotor yoke, and the pole shoe elements are mechanically connectable to the rotor teeth after arranging the rotor windings on the rotor teeth; and
wherein the rotor is rotatably mounted within the hollow cylindrical laminated core of the stator.
